(19) United States
(12) Patent Application Publication
(10) Pub. No.: US 2007/0002017 A1
(43) Pub. Date: Jan. 4, 2007

(54) Device, system and method for wireless communication and cursor pointing

(76) Inventor: Evgeny Mezhibovsky, Ramat-Gan (IL)

Correspondence Address: PEARL COHEN ZEDEK LATZER, LLP, 1500 BROADWAY, 12TH FLOOR, NEW YORK, NY, 10036, US

(21) Appl. No.: 11/170,110

(22) Filed: Jun. 30, 2005

(51) Int. Cl. G09G 5/08

(52) U.S. Cl. 345/158

(57) ABSTRACT

A method, device and system of combining a personal mobile communication device with a cursor pointing device, and for controlling for example a cursor or pointer that may be displayed on for example a personal computer or on a screen of a telephone, by way of the movements of a mobile personal communication device such as a cellular telephone.

### BACKGROUND OF THE INVENTION

Computers or other devices with electronic displays, such as for example laptop or notebook computers, typically include a built-in or attached cursor pointing device such as for example a track-point, touch-pad or four-way key device by which a user may move a cursor on a display. Many users find attached or wired cursor pointing devices inconvenient, and prefer the flexibility and dexterity afforded by a fully portable, hand-held cursor pointing device or ‘mouse’. Many users of personal computers also carry a hand-held phone or other mobile communication device such as for example a cellular hand set, cellular personal digital assistant or other cellular or wireless personal communication device.

### BRIEF DESCRIPTION OF THE FIGURES

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a bottom view of a combination cellular hand set and cursor pointing device with an optical sensor, in accordance with an exemplary embodiment of the invention;

FIG. 2 is a schematic diagram of a key pad of a combination cellular hand set and cursor pointing device, in accordance with an exemplary embodiment of the invention;

FIG. 3 is a schematic diagram of a system linking a combination cellular hand set and cursor pointing device to a computer, in accordance with an exemplary embodiment of the invention;

FIG. 4 is a schematic diagram of a system architecture of a combination cellular hand set and cursor pointing device and a personal computer, in accordance with an exemplary embodiment of the invention; and

FIG. 5 is a flow chart of a method of wireless communication and cursor pointing in accordance with an exemplary embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “processing,” “computing,” “calculating,” “determining,” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. For example, while the term computer or personal computer as used in this application may refer to for example a laptop, palmtop or desktop computer, such term may also refer to other electronic processing devices having a display with a cursor or other display pointing function. Furthermore, while the term cellular hand set, mobile communication device or mobile phone as used in this application may refer to for example a cellular telephone, such term may also refer to for example a personal digital assistant (that may or may not have cellular capabilities), a portable pager or message delivery device, such as for example a portable email device, or other portable, handheld electronic devices. In some embodiments such handheld electronic device may be or include for example a wrist watch or other wearable electronic device.

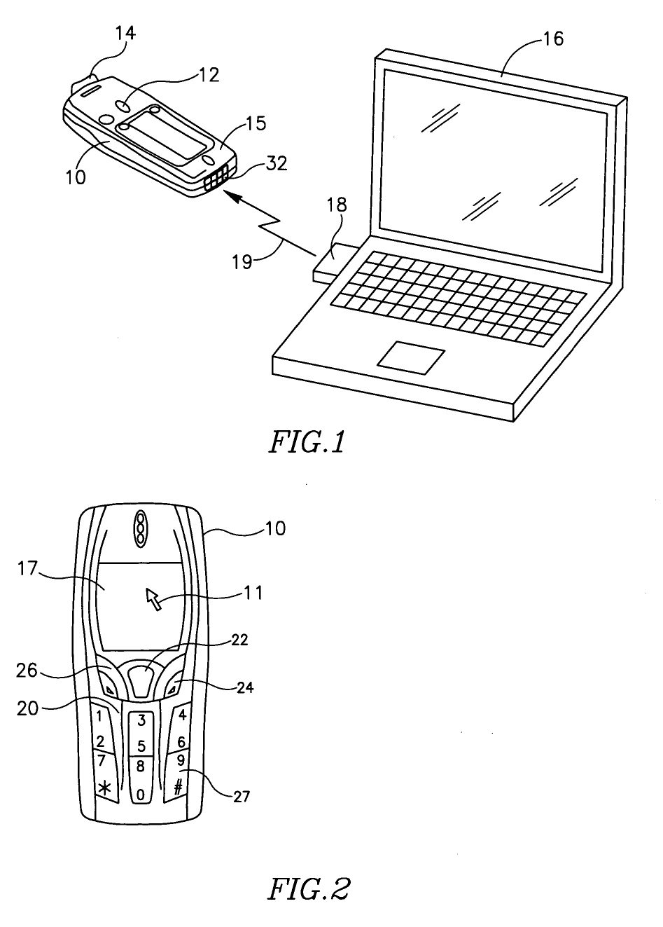

Reference is made to FIG. 1, a schematic diagram of a bottom view of a combination cellular hand set and cursor pointing device with a sensor, in accordance with an exemplary embodiment of the invention. Mobile phone 10 may be for example a cellular telephone or other voice or personalized message communication device, personal digital assistant, data communicator or visual content communicator that is hand-held and portable. Phone 10 may include some or all of the circuits, software, transmitter, receiver, power functions and display components as are included in cellular communication devices. Mobile phone 10 may provide some or all of the functions of cellular communication devices as are known in the art. Phone 10 may include a power source 15. In some embodiments, power source 15 may also provide power to sensor 12 and other components of a cursor pointing device.

Sensor 12 may in some embodiments be connected to or built into for example the back of a housing of phone 10 and may include any suitable position movement sensor known in the art such as for example a mouse ball or an optical sensor. In some embodiments, sensor 12 may be built into or attached to other parts of a housing of phone 10, or otherwise connected to the housing of phone 10. In some embodiments, sensor 12 may be detachably connected to the housing of phone 10 at a bottom portion thereof, and may receive power and transfer signals through leads or connectors 32 that may be located at such bottom portion. Sensor 12 may be connected, whether detachably or not, at other locations on the housing of phone 10, and may receive power and may transfer signals other than through leads or connectors 32. Sensor 12 may include a power source separate from the power source 15 of phone 10.

An optical sensor that may be included in sensor 12 may be or include for example a light producing component such as a light emitting diode or a laser, and an image capture processor and control circuitry, and may generally be similar in function and/or structure to components found in existing display pointers or cursor pointing devices such as for example, an optical mouse. Other devices suitable to provide a cursor pointing function may be included in or attached to phone 10.

In some embodiments, phone 10 may also include or be configured with a receiver and/or transmitter 14 that may be suitable to create a short range (from several inches to a few feet) wireless link between phone 10 and a computer 16 for the purpose of transmitting for example cursor pointing signals or other signals between phone 10 and computer 16. In some embodiments, transmitter 14 may be hidden and not visible from outside phone 10. Computer 16 may also include a wireless receiver and/or tansmitter 18 that may be suitable for receiving or transmitting short range signals from phone 10 such as for example cursor pointing signals or other signals, such as for example signals that are transmitted from a mouse or data entry device to a computer. Transmitter 14 may be or include for example an infra-red transmitter or other wireless transmitter and receiver suitable for communicating signals 19 between two electronic devices such as for example phone 10 and computer 16. In some embodiments, transmitter 14 may be suitable for use with for example a Bluetooth communication protocol or module. Other transmission protocols may be used.

In operation, phone 10 may operate as a phone or personal communication device, and as a cursor pointing device for, for example, computer 16. In some embodiments, a user may use for example a button 27 such as a press-button or other input devices of phone 10 to for example activate or engage the operation of sensor 12, and to put phone 10 into a cursor pointing device mode. Once the cursor pointing device is activated, a user may move or manipulate phone 10 onto for example a surface so that sensor 12 faces or is in contact with a surface such as for example a table, desk top or other surface, and so that sensor 12 moves relative to such surface when the housing of phone 10 moves on a surface. In some embodiments, when a cursor pointing device mode is activated, transmitter 14 may search for and establish a wireless communication link with between for example computer 16 and phone 10. A user may move or manipulate phone 10 as if phone 10 was a computer mouse or other cursor pointing device, and thereby, for example move or direct a cursor or other pointer around for example a display of computer 16. In some embodiments, one or more of the buttons of phone 10 may function as mouse buttons or data entry keys that may allow a user to for example, right-click, left-click, double-click or scroll through a display on computer 16, as such functions may typically be made available by a conventional mouse or other cursor pointing device. In some embodiments, a button may generate a cursor pointing signal that may be for example functionally comparable to the signals generated by a button on a standard mouse. Other data entry functions to computer 16 may also be provided through signals transmitted from transmitter 14.

In some embodiments, when a user may finish using phone 10 as a cursor pointing device, the user may for example use one or more buttons of phone 10 to for example disengage or deactivate sensor 12 and switch between a phone mode and a cursor pointing mode. When disengaged, the link between phone 10 and computer 16 may be for example terminated, and the press-buttons of phone 10 may again function as phone buttons.

In some embodiments, phone 10 may function simultaneously as both a cursor pointing device and a personal communication device, so that a user may for example make or receive calls while using phone 10 as a cursor pointing device.

Reference is made to FIG. 2, a diagram of a key pad of a cellular hand set in accordance with an exemplary embodiment of the invention. In some embodiments, when phone 10 is in cursor pointing device mode, buttons 27 on for example a key pad 20 of phone 10 may assume the functions of for example buttons 27 that may for example be typically found on a cursor control device such as a mouse. For example a four way key 22 may be used for example to scroll up, down or sideways through a document or display on computer 16 or on phone 10, similar to the function of a scroll wheel on a mouse or other cursor control device. In some embodiments, phone 10 may include a scroll wheel, and such scroll wheel may generate signals to move a cursor on a display or screen. In some embodiments, a right key 24 may function as a for example a right mouse button, and a left key 26 may function as a left mouse button. Other combinations, uses and functions of keys and buttons are possible. In some embodiments, a display 17 of phone 10 may include a cursor or pointer 11 whose movements may be controlled by for example sensor 12, such that sensor 12 may be used as a cursor pointing device for-operation of phone 10.

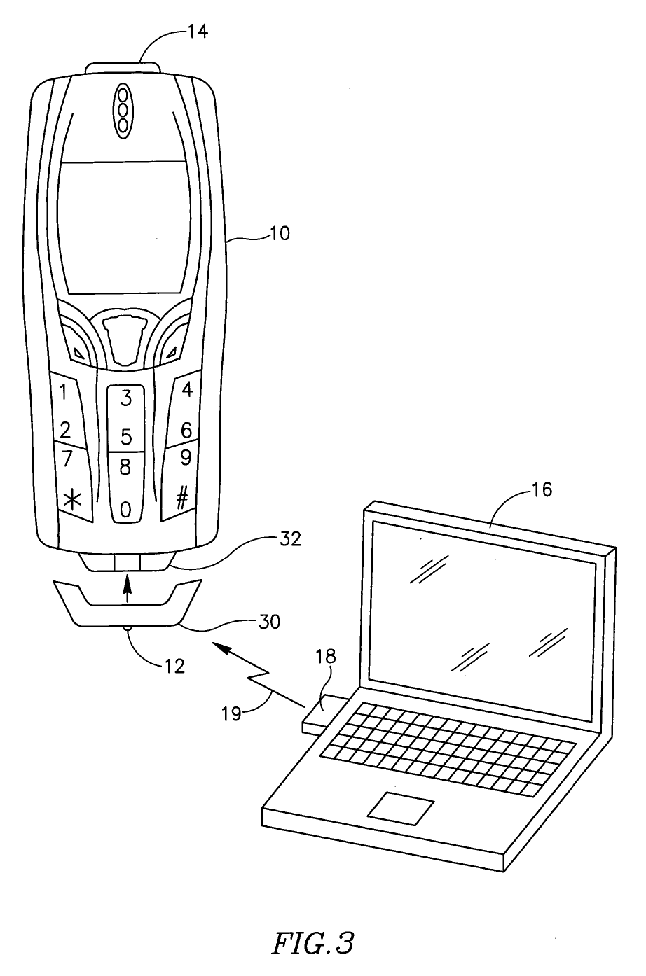

Reference is made to FIG. 3, a schematic diagram of a system linking a personal communication device, having an attachable and detachable cursor pointing device, to a personal computer, in accordance with an exemplary embodiment of the invention. In some embodiments, phone 10 may not include a built-in sensor for use in a cursor pointing function. An attachable cursor pointing device module 30 may be plugged into or otherwise connected to for example the leads or connectors 32 at, for example the bottom of phone 10. Other points and ways of attaching the cursor pointing device module 30 to the phone 10 are possible. Cursor pointing device module 30 may include connectors 32 and a sensor 12 such as for example an optical sensor or mouse ball. Cursor pointing device module 30 may have a separate power source such as for example a battery, or may draw power from the phone 10. In operation, signals, such as those produced by cursor pointing device module 30 may be passed through connectors 32 to circuitry in phone 10 and, in some embodiments, further to transmitter 14, for transmission to and from, for example computer 16.

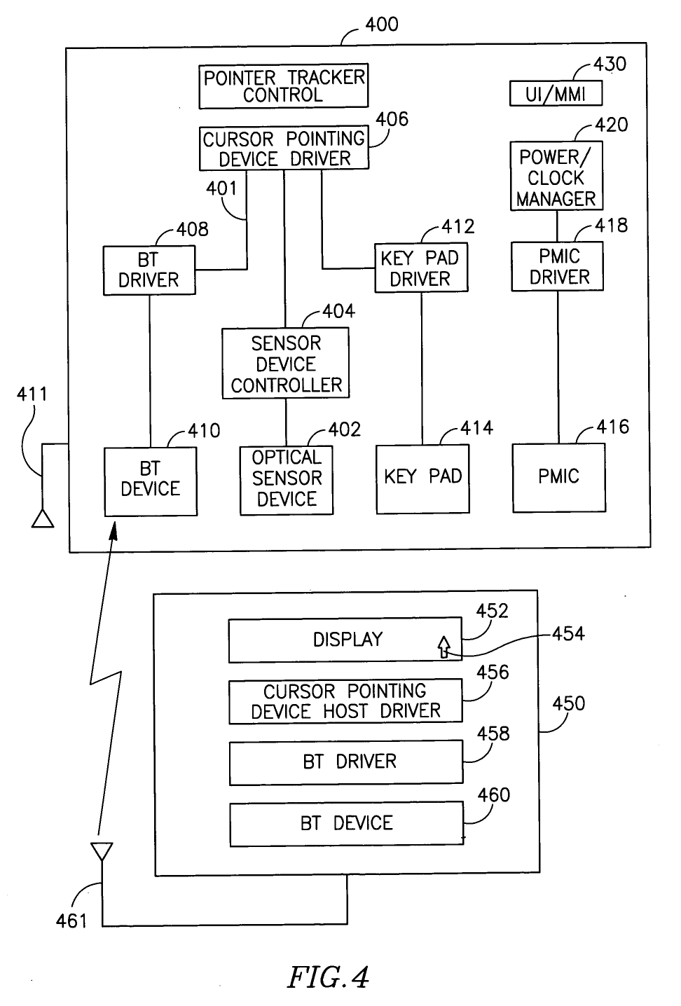

Reference is made to FIG. 4, a schematic diagram of a system architecture of a cursor pointing device-enabled personal communication device and a personal computer, in accordance with an exemplary embodiment of the invention. Portable and personal wireless communicator such as cellular phone 400 may include a cursor pointing device such as for example an optical sensor device 402. Sensor device 402 may be operably connected to a sensor device controller 404 that may be or include for example software or a combination of software and hardware that may control, amplify, convert or generate signals in response to symbols or data from optical sensor device 402. In some embodiments, sensor device controller 404 may be or include an image capture device. Sensor device controller 404 may be operably connected to cursor pointing device driver 406. In some embodiments cursor pointing device driver 406 may be or include software that may regulate or convert signals from sensor device controller 404 into for example cursor or pointer control signals that may be recognized by a computer 450 for movement of a cursor 454 on a computer display 452. In some embodiments, optical sensor device 402 may send signals or data directly to Bluetooth device 410, which may deliver such signals to computer 450.

Cursor pointing device driver 406 may be operably connected to a transmitter driver such as for example a Bluetooth driver 408, that may be connected to a transmitter device such as for example a Bluetooth transmitter 410 that may include an antenna 411. In some embodiments a Bluetooth tansmitter and Bluetooth driver may be replaced or complemented by an infra-red device and or infra-red driver or other transmitters and drivers.

Cursor pointing device driver 406 may receive signals from a key pad driver 412 which may control or regulate signals received from buttons on for example a key pad 414 or from a scroll wheel or four way button. Cursor pointing device driver 406 may receive signals from for example User Interface/Man Machine Interface 430. Such signals may for example alternate the operation of cursor pointing device driver 406 between use as a cursor pointing device for phone 400 and use as a cursor pointing device for computer 450. For example, in some embodiments, buttons on a phone may function as phone buttons or as cursor pointing device buttons depending on the mode a phone is in.

Phone 400 may include a power management integrated circuit (PMIC) 416 that may in some embodiments be controlled or regulated by a PMIC driver 418, which may be operably connected to a power/clock manager 420 of phone 400. In some embodiments, power for sensor device 402 may be supplied and/or controlled by for example PMIC 416, or other components in phone 400.

Phone 400 may include a user interface or man—machine interface 430 such as for example a screen.

Other components may be included in phone 400, and one or more components shown in FIG. 4 may be combined with other components into a single unit or into a fewer or greater number of components or units. Connections 401 between one or more of the components shown in FIG. 4 may be circuits or physical connections such as wires or leads, or may be software or other connections.

Computer 450 may be or include a personal computer such as for example a laptop, personal digital assistant or other portable or stationary processing device. Computer 450 may include a display 452 upon which may be shown a cursor or pointer 454 that may be controlled by for example a display driver or a cursor driver in computer 450. In embodiments of the invention, a movement of cursor 450 may be driven according to signals or data received from cursor pointing device driver 406, and the detected movements of optical sensor device 402.

Computer 450 may include a cursor pointing device host driver 456 that may for example interpret the signals received from cursor pointing device driver 406. Computer 450 may also include a transmitter/receiver such as for example a Bluetooth device 460 that may be controlled by for example a driver such as a Bluetooth driver 458. Computer 450 may include an antenna 461 that may be suitable for receiving and transmitting signals to and from for example phone 400.

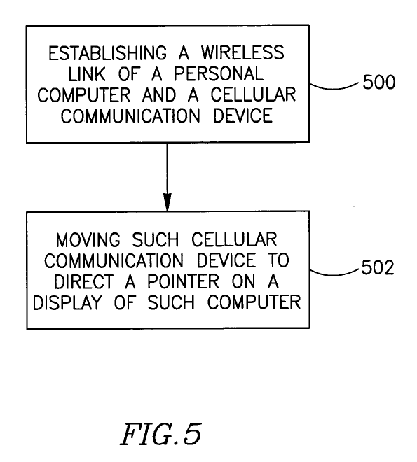

Reference is made to FIG. 5, a flow chart of a method in accordance with an exemplary embodiment of the invention. In block 500 a wireless link may be established between a computer, such as for example a personal computer, mobile computer such as a laptop or PDA, on the one hand, and a cursor pointing device connected to a housing of a cellular communication device such as for example a cellular phone, email reader/receiver or PDA, on the other hand. Such link may be established via infra-red signals, Bluetooth or other wireless protocols or transmitters and receivers.

In block 502, the movement of a cursor or pointer on a display of the computer may be directed by movement of the housing of the cellular communication device. The movement of the housing of the cellular communication device when it is placed on for example a surface may be tracked by for example a cursor pointing device module such as an optical cursor pointing device or mouse ball.

It will be appreciated by persons skilled in the art that embodiments of the invention are not limited by what has been particularly shown and described hereinabove. Rather the scope of at least one embodiment of the invention is defined by the claims below.

I claim:

1. A device comprising:
a mobile communication device;
a cursor pointing device connected to said mobile communication device; and
a press-button configured to control a function of said mobile communication device and a function of said cursor-pointing device.

2. The device as in claim 1, wherein said cursor pointing device comprises an optical sensor.

3. The device as in claim 1, comprising a power source to power said mobile communication device and said cursor pointing device.

4. The device as in claim 1, comprising a transmitter to transmit cursor control signals to a computer.

5. The device as in claim 4, wherein said transmitter comprises an infra-red transmitter.

6. The device as in claim 1, wherein said mobile communication device comprises a cellular telephone.

7. The device as in claim 1, wherein said cursor pointing device is detachably connected to said mobile communication device.

8. The device as in claim 1, wherein said transmitter comprises a blue tooth module.

9. The device as in claim 1, wherein said cursor pointing device is to direct a cursor on a screen of said mobile communication device.

10. The device as in claim 1, comprising a scroll wheel to generate a signal to move a cursor controlled by said cursor pointing device.

11. The device as in claim 1, comprising a switch configured to alternate a function of said button from a mobile communication device function to a cursor pointing device function.

12. A system comprising:
a cellular communication device;
a cursor pointing device; and
a wireless transmitter to transmit signals from said cursor pointing device to a computer.

13. The system as in claim 12, comprising a button to control a function of said cellular communication device and a function of said cursor pointing device.

14. The system as in claim 12, wherein said transmitter is an infra-red transmitter.

15. The system as in claim 12, comprising an optical sensor to detect a movement of said cursor pointing device.

16. The system as in claim 12, wherein said cellular communication device comprises a scroll wheel.

17. A method comprising:
establishing a wireless link between a computer and a cursor pointing device, said cursor pointing device connected to a housing of a cellular communication device ; and
moving said housing of said cellular communication device to direct a cursor on a display of said computer.

18. The method as in claim 17, wherein moving comprises moving said housing such that an optical sensor of said cursor pointing device moves relative to a surface.

19. The method as in claim 17, wherein said establishing comprises establishing a wireless link using a Bluetooth protocol.

20. The method as in claim 17, comprising detaching said cursor pointing device from said housing.
